(19) United States
(12) Patent Application Publication
(10) Pub. No.: US 2012/0279282 A1
(43) Pub. Date: Nov. 8, 2012

(54) Device and method to provide a pressure/vacuum test of a vehicle cylinder's sealing ability without a head on the engine

(76) Inventor: Billy Williams, Wills Point, TX (US)

(21) Appl. No.: 13/101,893

(22) Filed: May 5, 2011

(51) Int. Cl. G01M 3/04

(52) U.S. Cl. 73/49.7

(57) ABSTRACT

A device for pressure testing an engine block may include a sealing device to mount on the engine block and to seal the engine block, a fastening device to fasten the sealing device to the engine block and a connecting rod to connect the sealing device to the fastening device. The sealing device may include a layer of adhesive on the bottom surface of the sealing device, and the sealing device includes a substantial cylinder. The sealing device may include a aperture, and the sealing device may include a threaded port.

### FIELD OF THE INVENTION

The present invention relates to testing the pressure response of an engine cylinder and more particularly to testing the pressure of the engine cylinder without a head on the engine.

### BACKGROUND

In order to provide efficient engine operation in vehicles, a pressure test should the employed. The proper cylinder pressure should be maintained so that the proper combustion mix of fuel and air can be achieved to provide a satisfactory combustion. However, whenever damage may occur to a cylinder or to a valve, the proper cylinder pressure may not be able to be maintained. In order to test for this situation, a compression test may be performed by removing a spark plug from a suspect cylinder and replacing the spark plug with a pressure gauge. The crankshaft is turned on and the pressure can be obtained from the pressure gauge.

In a similar test, a leak down or cylinder leakage test provides an indication as to how well the engine cylinders are sealing. However, instead of measuring pressure resulting from the cylinders the test measures pressure loss as a result of induced pressure dissipating through the engine block.

The leak down test requires the removal of all the spark plugs, and the crankshaft is turned so that each piston is at top dead center (both valves close, when each cylinder is tested.

A threaded coupling may be attached to a leak each gauge and screws into the spark plug hole. Compressed air is then fed into the cylinder. The amount of leakage can be determined and provides an indication of the amount of engine damage. The leak may be faster and easier than the compression test to determine where the pressure is leaking from. Air which may come out of the breather vent or PCV valve fitting may indicate that the rings and/or cylinders are worn. If the air comes out the tailpipe, this would indicate a leaky exhaust valve.

The leakage test may be used in conjunction with the compression test to diagnose other types of problems.

A cylinder that has poor compression but minimal leakage usually has a valve train problem such as a warm can lobe, broken valve spring, collapsed lifter, bent push rod, etc.

If the cylinders have a low compression but show minimal leakage, the cause may be incorrect valve timing. The timing belt or chain may be off a notch or two.

If the compression is good and the leakage is minimal but the cylinder is misfiring or shows a weak power balance test, this shows a fuel delivery (bad injector) or ignition problem (fouled spark plug or bad plug wire).

### SUMMARY

A device for pressure testing an engine block may include a sealing device to mount on the engine block and to seal the engine block, a fastening device to fasten the sealing device to the engine block and a connecting rod to connect the sealing device to the fastening device.

The sealing device may include a layer of adhesive on the bottom surface of the sealing device, and the sealing device includes a substantial cylinder.

The sealing device may include a aperture, and the sealing device may include a threaded port.

The fastening device may be a substantial rectangle, and the pressure testing device may include a extending device to cooperate with the sealing device and the engine block.

The extending device may be a ring.

A method for pressure testing an engine may include the steps of removing an engine head from an engine block, mounting a pressure testing device on the engine block and pressure testing the engine block without the engine head being positioned on the engine block with the pressure testing device.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of an engine of the present invention;

FIG. 2 illustrates a cross-sectional view of the sealing device and the fastener device of the present invention;

FIG. 3 illustrates a top view of the fastener device of the present invention;

FIG. 4 illustrates a bottom view of the fastener device of the present invention;

FIG. 5 illustrates a side view of the fastener device of the present invention;

FIG. 6 illustrates a perspective view of the fastener device and sealing device of the present invention;

FIG. 7 illustrates a cross-sectional view of the centering rod of the present invention;

FIG. 8 illustrates a cross-sectional view of the spacer of the present invention;

FIG. 9 illustrates a cross-sectional view of the handle of the present invention;

FIG. 10 illustrates a bottom view of the sealing device of the present invention;

FIG. 11 illustrates a measuring device of the present invention;

FIG. 12 illustrates a top view of the sealing device of the present invention;

FIG. 13 illustrates a perspective view of the fitting/adapter of the present invention;

FIG. 14 illustrates a top view of the extending device of the present invention;

FIG. 15 illustrates a side view of the extending device of the present invention;

FIG. 16 illustrates a bottom view of the extending device of the present invention;

FIG. 17 illustrates the pressure testing device of the present invention being applied to the engine block;

FIG. 18 illustrates an exploded view of the pressure testing device of the present invention and the engine block;

FIG. 19 illustrates the pressure testing device connected to the engine block.

### DETAILED DESCRIPTION

The pressure testing device 100 may be used to make it possible to perform a leak down test and vacuum test in a cylinder without cylinder head attached to the engine.

When testing an engine, a compression test is normally done to look for abnormalities or inconsistencies between cylinders or what pressure a cylinder(s) is able to reach. This compression test is a basic first step when diagnosing an internal engine problem.

If problem as a result of the compression test is found, the next step could/should be a leak down test. This leak down test is similar to a compression test, but the leak down test should be performed with the piston at top dead center of a cylinder so that intake and exhaust valves are closed, and then compressed air is released into the combustion chamber to measure the amount of pressure the cylinder can maintain. This possibly will tell the location of the pressure loss in the cylinder/combustion chamber. Air leaking from tail pipe indicates an exhaust valve issue; Air leaking from intake indicates an intake valve issue; Air leaking from crankcase would indicate sealing ring issue; air leaking into the cooling system or to another cylinder would indicate an head gasket issue. This leak down test will help determine further the severity of the problem and help isolate the issue.

These tests are performed via the threaded spark plug hole as the access point in the cylinder head.

Once an engine has been torn down (removal of head/heads) to inspect the damage and extent of needed repair, it is usually obvious to someone with knowledge of engines as to what has happened to the engine and what repairs are required concerning the cylinder head or head gasket. What is problematic is the condition of the cylinders and their sealing/vacuum ability before the cylinder head is reinstalled. There is a need for a quick and economical way to isolate and pressure test the piston, piston rings, cylinders individually without the cylinder head being reinstalled to seal off the cylinder and to repeat the compression test and or the leak down test as described above.

The present invention provides a pressure testing device 100 having the capability to perform a leak down test and a vacuum test without the engine being removed or torn down any further. This pressure testing device 100 may provide an access port and seal off cylinder for testing at substantially all of the positions of a piston in a cylinder bore allow checking for swells, cracks, galls, piston/ring sealing or other issues not found or able to isolate currently.

The pressure testing device 100 can be used with an optional spacer to compensate for engines where the piston protrudes past the deck; an index gauge can be fitted to gauge position of the piston in the cylinder during testing.

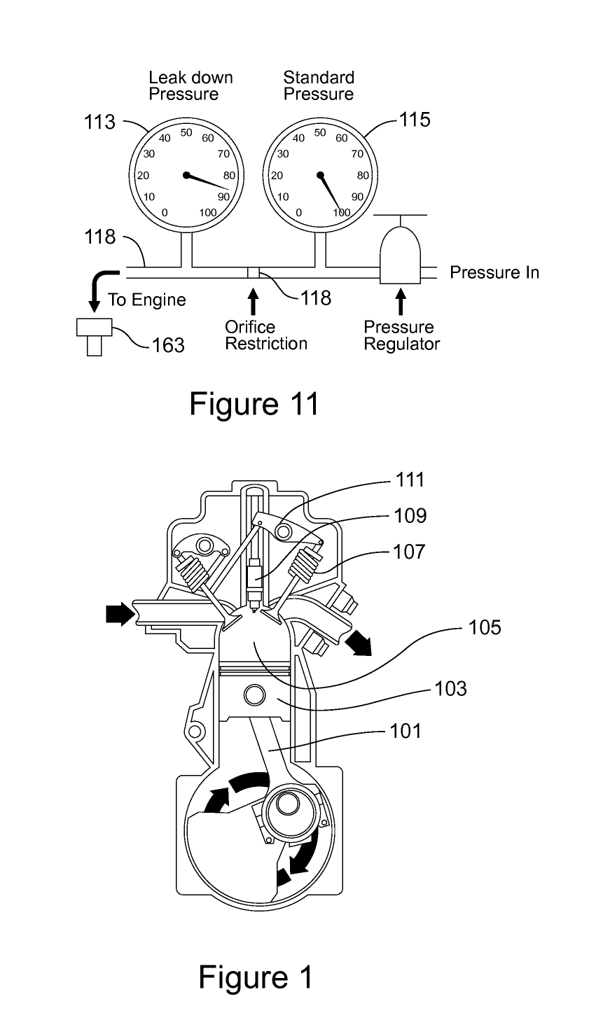

FIG. 1 illustrates the basic hemi engine design and illustrates a connecting rod 101 to connect to the piston 103 to compress the fuel mixture within a combustion chamber 105. The fuel mixture may be determined by valve and spring 107 which may be controlled by a rocker arm 111 and the fuel mixture may be ignited by a spark plug 109.

These types of tests may be advantageously performed before repairs to the engine had been initiated. However, once the engine head has been removed, the engine may require a second pressure test or a leak down test in order to confirm that the repairs have fixed the problem or confirm that the repairs have been correctly applied to the engine. In order to perform the test, the head needs to be reapplied to the engine which may require a significant amount of time. If there is a additional problem or if the repairs have not been correctly made, then the engine head may have to be removed and the process started again.

Needless to say, this would entail a significant amount of work.

The present invention provides a device and method in order to apply a pressure or leak down test without the requirement of reinstalling the engine head. The present invention includes a pressure testing device 100 which may be directly connected to the engine block without the engine head being attached to the engine block.

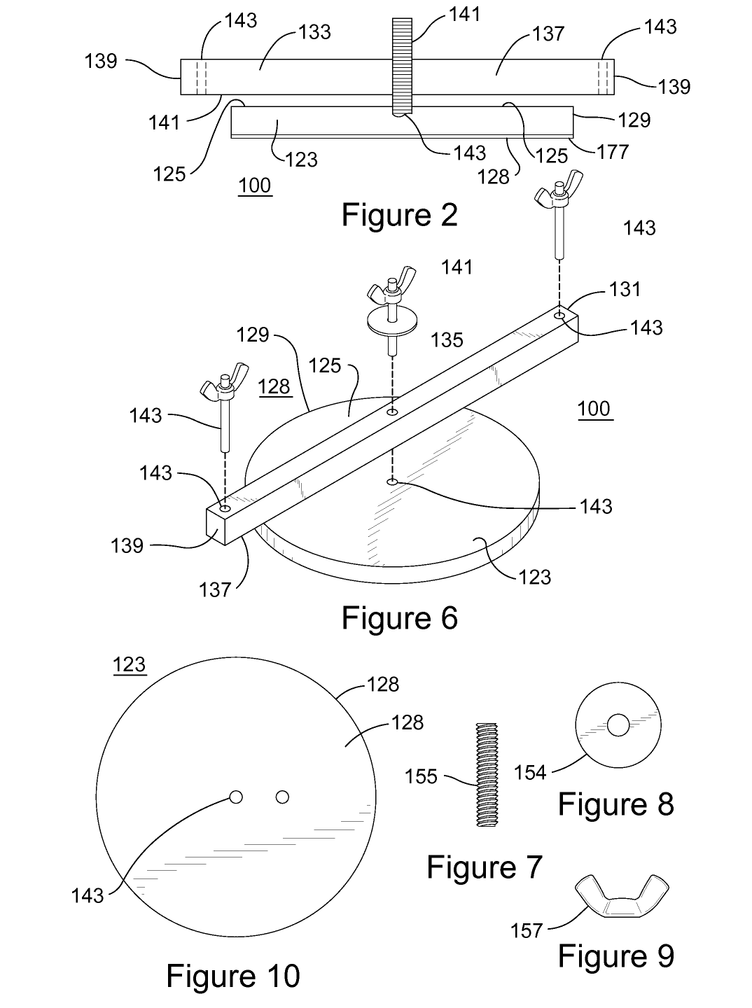

FIG. 2 illustrates a side view of the pressure testing device 100 which may include a sealing device 123, a fastening device 131 and a connecting rod 133 to connect the fastening device 131 to the sealing device 123. The fastening device 131 may be fastened to the engine block by the threaded apertures that are used by the head of the engine, and the fastening device 131 may be an elongated rectangle and may be substantially solid and formed from appropriate material such as metal, wood, plastic or other appropriate material. The fastener device 131 may include a top surface 135 which may connect to a side surface 137 and may connect to a end surface 139. The side surface 137 and the end surface 139 may connect to a bottom surface 141 which may be opposed to the top surface 135. The fastener device 131 may include a pair of opposing apertures 143 which may cooperate with connecting devices 143 (not shown in FIG. 2).

The sealing device 123 may be a cylinder and may be solid or hollow to seal the engine block 151 and may include a top surface 125 which may be defined by a side surface 129 which may be connected to a bottom surface 127. The sealing device 123 may be formed from metal, wood or plastic or other appropriate material. The bottom surface 127 may include an adhesive film 128 to adhere to the top surface of the engine block 151.

FIG. 2 additionally illustrates a centering rod 141 extending from the sealing device 123 and extending through the fastener device 131, and the centering rod 141 may include male threads in order to engage the sealing device 123 which may include a center aperture 143 having female threads.

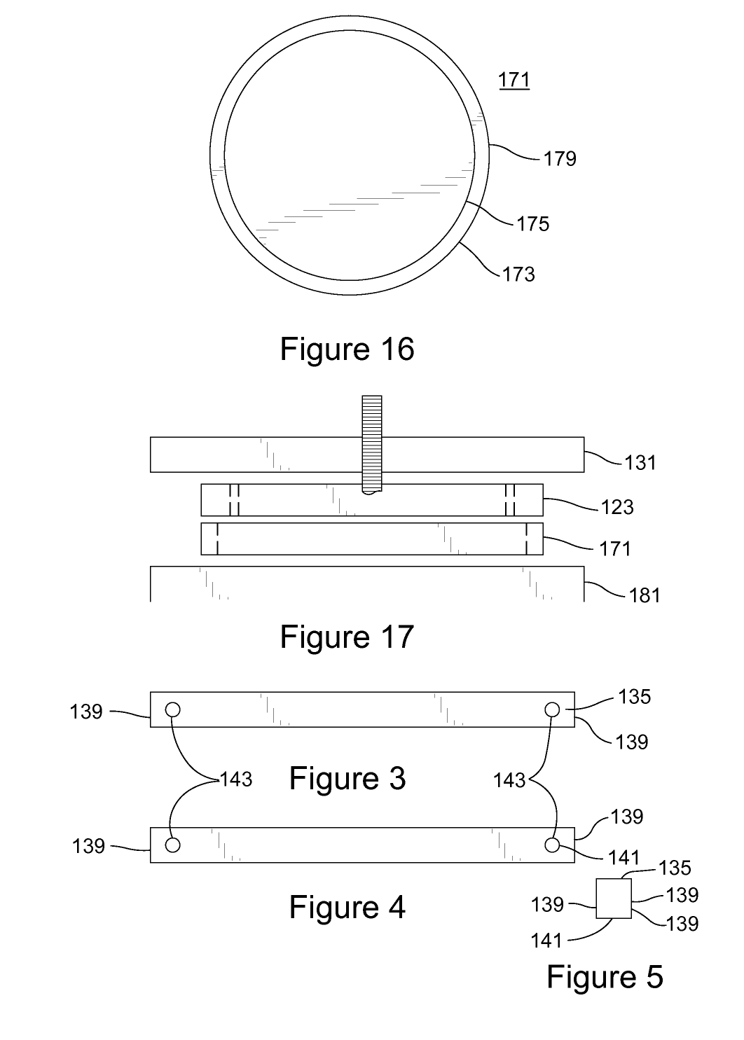

FIG. 3 illustrates a top view of the fastener device 131 which may include a top surface 135 which may connect to a side surface 137 and may connect to an end surface 139. The side surface 137 and the end surface 139 may connect to a bottom surface 141 which may be opposed to the top surface 135. The fastener device 131 may include a pair of opposing apertures 143 which may cooperate with connecting devices 143.

FIG. 4 illustrates a bottom view of the fastener device 131 which may include a top surface 135 which may connect to a side surface 137 and may connect to an end surface 139. The side surface 137 and the end surface 139 may connect to a bottom surface 141 which may be opposed to the top surface 135. The fastener device 131 may include a pair of opposing apertures 143 which may cooperate with connecting devices 143.

FIG. 5 illustrates an end view of the fastener device 131 which may include a top surface 135 which may connect to a side surface 137 and may connect to an end surface 139. The side surface 137 and the end surface 139 may connect to a bottom surface 141 which may be opposed to the top surface 135. The fastener device 131 may include a pair of opposing apertures 143 which may cooperate with connecting devices 143.

FIG. 6 illustrates a perspective view of the pressure testing device 100 which may include a sealing device 123, a fastening device 131 and a connecting rod 133 to connect the fastening device 131 to the sealing device 123. The fastening device 131 may be fastened to the engine block by the threaded apertures that are used by the head of the engine, and the fastening device 131 may be an elongated rectangle and may be substantially solid and formed from appropriate material such as metal, wood, plastic or other appropriate material. The fastener device 131 may include a top surface 135 which may connect to a side surface 137 and may connect to a end surface 139. The side surface 137 and the end surface 139 may connect to a bottom surface 141 which may be opposed to the top surface 135. The fastener device 131 may include a pair of opposing apertures 143 which may cooperate with connecting devices 143 which may be a threaded bolt.

The sealing device 123 may be a cylinder and may be solid or hollow to seal the engine block 151 and may include a top surface 125 which may be defined by a side surface 129 which may be connected to a bottom surface 127. The bottom surface 127 may include an adhesive film/layer 128 to adhere to the top surface of the engine block 151.

FIG. 6 additionally illustrates a centering rod 141 extending from the sealing device 123 and extending through the fastener device 131, and the centering rod 141 may include male threads in order to engage the sealing device 123 which may include a center aperture 143 having a female threads.

FIG. 7 illustrates a bolt 155 of the connecting device 143, and FIG. 8 illustrates a spacer 159.

FIG. 9 illustrates a handle 157 which cooperates with the bolt 155 and the spacer 159 to form the connecting device 143. The connecting device 143 is placed through the apertures 143 and is connected to the engine head 151 which may have female threads to cooperate with the male threads of the bolt 155.

FIG. 10 illustrates a bottom view of the sealing device 123 and illustrates the adhesive film/layer 128 which may be formed on the bottom surface 127 of the sealing device 123. FIG. 10 additionally illustrates the center aperture 143 and illustrates a threaded port 161 which may extend through the sealing device 123 and cooperate with a fitting/adapter 163 to connect to a pressure hose 163 as illustrated in FIG. 11.

FIG. 11 illustrates a device to measure the leak down pressure and the standard pressure. FIG. 11 illustrates a first pressure gauge 113 to measure the leak down pressure as described above and a second pressure gauge 115 to measure the pressure for a pressure test as described above. FIG. 11 illustrates a pressure regulator 117 within the pressurized tube 118 which is connected to the fitting/adapter 163. FIG. 11 additionally illustrates an tube restriction device 117 to restrict the flow in the pressurized tube 118.

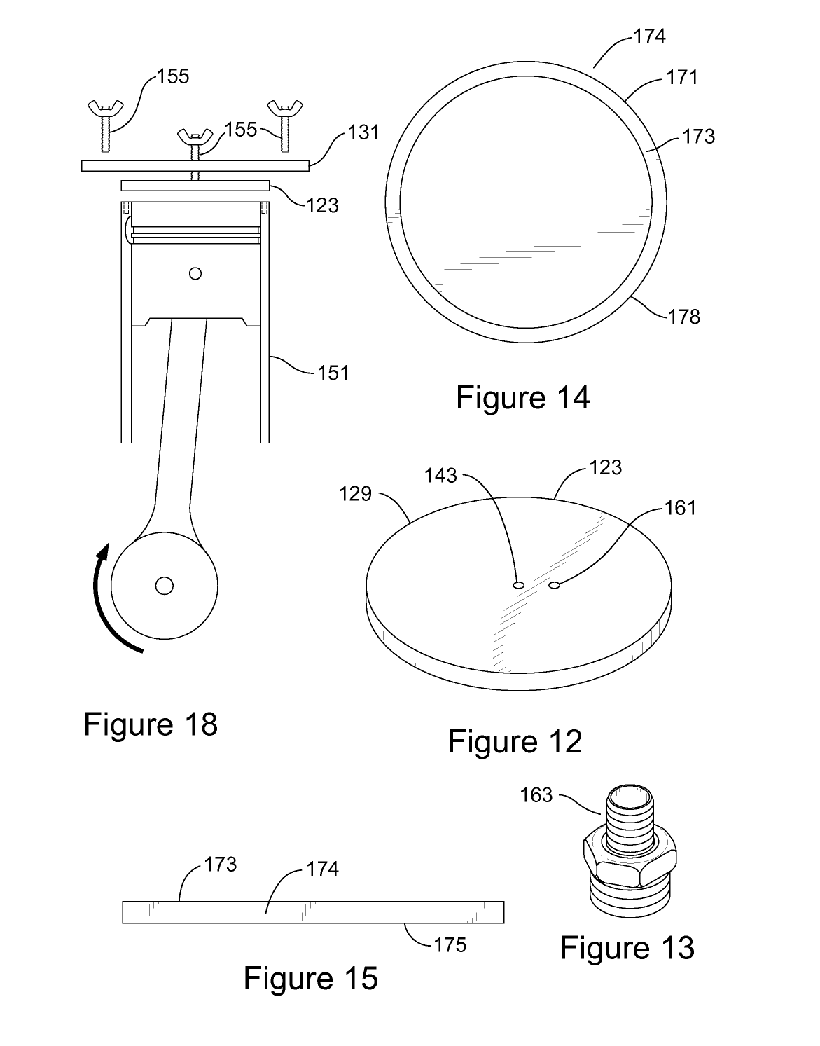

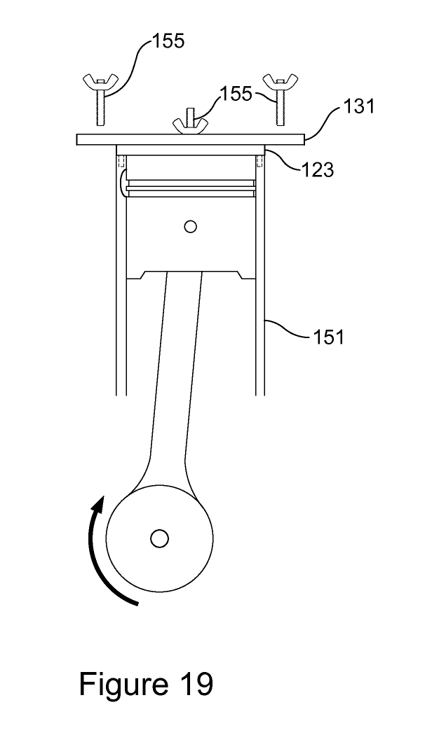

FIG. 12 illustrates a top view of the sealing device 123 and illustrates the top surface 125 and the side surface 129 of the sealing device 123. FIG. 12 additionally illustrates the center aperture 143 and illustrates a threaded port 161 which may extend through the sealing device 123 and cooperate with a fitting/adapter 163 to connect to a pressure hose 163 as illustrated in FIG. 11.

FIG. 13 illustrates a perspective view of the fitting/adapter 163.

FIG. 14 illustrates a top view of the extending device 171 which may be a ring which may have a diameter substantially equal to the diameter of the sealing device 123. Some engines have a piston which may extend out of the engine block when the engine head has been removed. In these cases, it may be necessary to employ the extending device 117 which may be placed between the engine block and the sealing device 123. This allows the piston to avoid impacting the sealing device 123.

The extending device 171 may have a top surface 173 which may cooperate with the bottom surface 127 of the sealing device 123 and which may be connected to the side surface 174 which may be connected to the bottom surface 175 which may cooperate with the top surface of the engine block.

FIG. 15 illustrates side view of the extending device 171 which may be a ring which may have a diameter substantially equal to the diameter of the sealing device 123.

The extending device 171 may have a top surface 173 which may cooperate with the bottom surface 127 of the sealing device 123 and which may be connected to the side surface 174 which may be connected to the bottom surface 175 which may cooperate with the top surface of the engine block.

FIG. 16 illustrates a bottom view of a extending device 171 which may be a ring which may have a diameter substantially equal to the diameter of the sealing device 123.

The extending device 171 may have a top surface 173 which may cooperate with the bottom surface 127 of the sealing device 123 and which may be connected to the side surface 174 which may be connected to the bottom surface 175 which may cooperate with the top surface of the engine block.

FIG. 17 illustrates the sealing device 123, the fastener device 131 and the extending device 171 being installed on the engine block 151.

FIG. 18 illustrates an exploded view of the sealing device 123, the fastener device 131, the bolts 155 and the handle 151.

In operation, the engine head is removed from the engine block and the repairs are made to the engine block, pistons or other internal engine parts. The pressure testing device 100 is applied by placing the sealing device 123 on the engine block 151, the fastener device 131 is placed over the sealing device 123, a seal with the engine block is achieved by tightening the bolts 155 into the engine block 151, and the handle 157 cooperates with the spacer 159 to tighten the fastener device 131 to the sealing device 123 and to the engine block 151. The fitting/adapter 163 is placed into the threaded port 161 and pressure, by a pressurized fluid such as air, is introduced into the pressure hose 118 and into the engine block 151 through the fitting/adapter 163. If the pressure is maintained within the engine block by using the first gauge 113 or the second gauge 115 then the repairs may be deemed a success and the head can be installed. If the pressure is not maintained, then additional repairs can be affected without installing the engine head and consequently, saving time and cost.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A device for pressure testing an engine block, comprising:
a sealing device to mount on the engine block and to seal the engine block,
a fastening device to fasten the sealing device to the engine block;
a connecting rod to connect the sealing device to the fastening device.

2) A device for pressure testing an engine block as in claim 1, wherein the sealing device includes a layer of adhesive on the bottom surface of the sealing device.

3) A device for pressure testing an engine block as in claim 1, wherein the sealing device includes a substantial cylinder.

4) A device for pressure testing an engine block as in claim 1, wherein the sealing device includes a aperture.

5) A device for pressure testing an engine block as in claim 1, wherein the sealing device includes a threaded port.

6) A device for pressure testing an engine block as in claim 1, wherein the fastening device is a substantial rectangle.

7) A device for pressure testing an engine block as in claim 1, wherein the pressure testing device includes a extending device to cooperate with the sealing device and the engine block.

8) A device for pressure testing an engine block as in claim 7, wherein the extending device is a ring.

9) A method for pressure testing an engine, comprising the steps of:
removing an engine head from an engine block;
mounting a pressure testing device on the engine block;
pressure testing the engine block without the engine head being positioned on the engine block with the pressure testing device.
